(19) United States
(12) Patent Application Publication
(10) Pub. No.: US 2025/0192466 A1
(43) Pub. Date: Jun. 12, 2025

(54) RELIABLE HYBRID ELECTRICAL CONNECTOR

(71) Applicant: Amphenol Commercial Products (Chengdu) Co., Ltd., Chengdu (CN)

(72) Inventors: Nan Qiu, Chendgu (CN); Tao Zeng, Chengdu (CN); Ki Ka Lau, Kowloon (HK)

(73) Assignee: Amphenol Commercial Products (Chengdu) Co., Ltd., Chengdu (CN)

(21) Appl. No.: 18/976,186

(22) Filed: Dec. 10, 2024

(30) Foreign Application Priority Data
Dec. 11, 2023 (CN) 202323381973.8

(51) Int. Cl. H01R 13/424; H01R 12/71

(52) U.S. Cl. CPC H01R 13/424; H01R 12/716

(57) ABSTRACT

Reliable hybrid electrical connectors are provided. A connector can have conductive elements each having a mating end, a tail end, and an intermediate portion joining the mating end and the tail end. The intermediate portion comprises a curved portion, a first straight portion joining the curved portion and the mating end, and a second straight portion joining the curved portion and the tail end. A connector housing comprises a body having a front, mating face and a rear face, and first and second arms extending from the rear face of the body and away from the mating face. An insulative member is disposed between the first and second arms of the housing and holds at least a portion of the second straight portion of the intermediate portion of each conductive element. The insulative member can be configured to restrain movements of the conductive elements, improving the reliability of the connector.

### CROSS-REFERENCE TO RELATED APPLICATIONS

This application claims priority to and the benefit of Chinese Patent Application No. 202323381973.8, filed on Dec. 11, 2023. The contents of this application are incorporated herein by reference in their entirety.

### TECHNICAL FIELD

This application relates generally to electrical interconnection systems, such as those including electrical connectors, used to interconnect electronic assemblies.

### BACKGROUND

Electrical connectors are used in many electronic systems. It is generally easier and more cost-effective to manufacture a system as separate electronic subassemblies, such as printed circuit boards (PCBs), which may be joined together by electrical connectors. Having separable electrical connectors enables components of the electronic system manufactured by different manufacturers to be readily assembled. Separable electrical connectors also enable components to be readily replaced after the system is assembled, either to replace defective components or to upgrade the system with higher-performance components.

### SUMMARY

Aspects of the present disclosure relate to reliable hybrid electrical connectors.

Some embodiments relate to an insulative member for restraining movement of conductive elements of an electrical connector. The insulative member may include a first portion comprising a top surface, a bottom surface, and a plurality of first channels extending from the top surface to the bottom surface, each of the plurality of first channels configured for holding at least a portion of a respective first conductive element of the electrical connector, the plurality of first channels disposed in first and second rows aligned in a mating direction of the electrical connector, each of the first and second rows extending in a longitudinal direction perpendicular to the mating direction; and a second portion connected to and aligned with the first portion in the longitudinal direction, the second portion comprising a first top surface, a second top surface offset from the first top surface in a vertical direction perpendicular to the longitudinal direction, a bottom surface, and a plurality of second channels, each of the plurality of second channels configured for holding at least a portion of a respective second conductive element of the electrical connector, the plurality of second channels comprising a first row of second channels extending from the first top surface to the bottom surface, and a second row of second channels extending from the second top surface to the bottom surface.

Optionally, the insulative member may comprise a first resilient latch arm extending from a first end surface of the first portion and comprising a first locking end extending beyond the first end surface in the longitudinal direction.

Optionally, the first portion comprises a first protrusion protruding from the first end surface in the longitudinal direction and offset from the first resilient latch arm in the mating direction.

Optionally, the insulative member may comprise a second resilient latch arm extending from a second end surface of the second portion and comprising a second locking end extending beyond the second end surface in the longitudinal direction.

Optionally, the top surface of the first portion is disposed between the first and second top surfaces of the second portion in the vertical direction.

Optionally, the bottom surfaces of the first and second portions are flush with each other.

Optionally, each of the plurality of first channels comprises a first channel portion extending to the bottom surface and a second channel portion extending to the top surface, the second channel portion connected to and aligned with the first channel portion in the vertical direction; and the second channel portion of each of the plurality of first channels has a T-shaped cross-section in a plane perpendicular to the vertical direction.

Optionally, each of the plurality of second channels comprises a narrower portion extending to the bottom surface, and a wider portion extending to either the first top surface or the second top surface, the wider portion connected to and aligned with the narrower portion in the vertical direction.

Some embodiments relate to an electrical connector. The electrical connector may include a housing comprising a body having a front, mating face and a rear face, and first and second arms extending from the rear face of the body and away from the mating face; and the insulative member described herein disposed between the first and second arms of the housing.

Some embodiments relate to an electrical connector. The electrical connector may include a housing comprising a body having a front, mating face and a rear face, and first and second arms extending from the rear face of the body and away from the mating face; a plurality of conductive elements, each of the plurality of conductive elements comprising a mating end, a tail end, and an intermediate portion joining the mating end and the tail end, the intermediate portion comprising a curved portion, a first straight portion joining the curved portion and the mating end, and a second straight portion joining the curved portion and the tail end; and an insulative member configured to restrain movements of the plurality of conductive elements, the insulative member disposed between the first and second arms of the housing and holding at least a portion of the second straight portion of the intermediate portion of each of the plurality of conductive elements.

Optionally, the plurality of conductive elements comprise a plurality of first conductive elements configured for transmitting signals, and a plurality of second conductive elements configured for transmitting power; and the body of the housing comprises a first portion holding the mating end and at least a portion of the first straight portion of the intermediate portion of each of the plurality of first conductive elements, a second portion holding the mating end and at least a portion of the first straight portion of the intermediate portion of each of the plurality of first conductive elements, and a slot extending from the first portion to the second portion in a longitudinal direction and accessible from the mating face; and the mating ends of the plurality of conductive elements accessible from the slot.

Optionally, the insulative member comprises a plurality of channels; and each of the plurality of channels comprises a first channel portion configured to receive a portion of the curved portion of the intermediate portion of each of the plurality of conductive elements, and a second channel portion narrower than the first channel portion in at least one direction and configured to hold the at least a portion of the second straight portion of the intermediate portion of each of the plurality of conductive elements.

Optionally, the insulative member comprises a front face abutting against the rear face of the housing.

Optionally, the first and second arms of the housing comprise first and second arm surfaces facing each other; and the insulative member comprises a first end surface, and a first resilient latch arm extending from the first end surface and configured to engage with the first arm surface of the first arm of the housing.

Optionally, the first arm comprises a first arm surface and a first groove recessed into the first arm from the first arm surface; and the first resilient latch arm comprises a first locking end configured to engage with the first groove.

Optionally, the insulative member comprises a second end surface opposite to the first end surface, and a second resilient latch arm extending from the second end surface and configured to engage with the second arm surface of the second arm of the housing.

Optionally, the second arm comprises a second arm surface and a second groove recessed into the second arm from the second arm surface; and the second resilient latch arm comprises a second locking end configured to engage with the second groove.

Optionally, the first arm further comprises a first recess in the first arm from the first arm surface; the second arm further comprises a second recess in the second arm from the second arm surface; and the insulative member further comprises a first protrusion protruding from the first end surface and configured to engage with the first recess, and a second protrusion protruding from the second end surface and configured to engage with the second recess.

Some embodiments relate to an electronic system. The electronic system may include a circuit board comprising a surface; and an electrical connector mounted on the circuit board. The electrical connector may include a housing comprising a body having a bottom face configured to disposed on the surface of the circuit board, a front, mating face, a rear face, and first and second arms extending from the rear face of the body and away from the mating face; a plurality of conductive elements, each of the plurality of conductive elements comprising a mating end, a tail end, and an intermediate portion joining the mating end and the tail end, the intermediate portion comprising a curved portion; and an insulative member configured to restrain movements of the plurality of conductive elements, the insulative member disposed between the first and second arms of the housing and comprising a bottom face flush with the bottom face of the housing.

Optionally, the first arm and the second arm comprise a first bottom surface and a second bottom surface, respectively; and the first bottom surface and the second bottom surface are flush with the bottom face of the insulative member.

Some embodiments relate to an electrical connector for establishing an electrical connection between a circuit board and an electrical component. The electrical component comprises: an insulative housing; a plurality of conductive elements disposed in the insulative housing, each of the plurality of conductive elements comprising a mating end, a tail end opposite to the mating end, and an intermediate portion extending between the mating end and the tail end, the mating end configured for mating with a corresponding conductive portion of the electrical component, and the tail end configured for mounting to the circuit board, the intermediate portion comprising a curved portion curved such that the tail end and the mating end are oriented to be substantially perpendicular to each other; and an insulative member mounted to the insulative housing and surrounding and holding at least a portion of the intermediate portion of each of the plurality of conductive elements between the curved portion and the tail end.

Optionally, the tail end is oriented in a vertical direction, and the mating end is oriented in a lateral direction substantially perpendicular to the vertical direction. The insulative housing comprises: a body, the intermediate portion of each of the plurality of conductive elements extending out of the body in the lateral direction and curved to extend to the tail end in the vertical direction; and a first arm and a second arm extending from the body in the lateral direction to opposite sides of the plurality of conductive elements in a longitudinal direction substantially perpendicular to the vertical direction and the lateral direction, respectively. The insulative member is disposed between the first arm and the second arm and is retained in position relative to the insulative housing by the first arm and the second arm.

Optionally, the body comprises a first end and a second end opposite to each other in the longitudinal direction, and the first arm and the second arm are positioned adjacent to the first end and the second end, respectively.

Optionally, the first arm and the second arm are integrally formed with the body, the intermediate portion of each of the plurality of conductive elements extends out of a first surface of the body, and the first arm and the second arm extend from the first surface of the body.

Optionally, the insulative member is configured to be inserted between the first arm and the second arm in the vertical direction.

Optionally, the insulative member comprises a first end surface and a second end surface opposite to each other in the longitudinal direction, and a first resilient latch arm and a second resilient latch arm, the first resilient latch arm comprises a first locking end extending beyond the first end surface in the longitudinal direction, and the second resilient latch arm comprises a second locking end extending beyond the second end surface in the longitudinal direction, the first arm comprises a first arm surface and a first retention groove recessed into the first arm from the first arm surface, and the second arm comprises a second arm surface and a second retention groove recessed into the second arm from the second arm surface, the first arm surface and the second arm surface are opposing to each other in the longitudinal direction, when the insulative member is disposed between the first arm and the second arm, the first end surface faces the first arm surface and the second end surface faces the second arm surface, the first resilient latch arm, the second resilient latch arm, the first retention groove and the second retention groove are configured such that when the insulative member is inserted between the first arm and the second arm, the first locking end engages with the first retention groove in the vertical direction and the second locking end engages with the second retention groove in the vertical direction to restrict a withdrawal of the insulative member in the vertical direction.

Optionally, the insulative member further comprises a first protrusion protruding from the first end surface in the longitudinal direction and a second protrusion protruding from the second end surface in the longitudinal direction, the first arm further comprises a first recess recessed into the first arm from the first arm surface, and the second arm further comprises a second recess recessed into the second arm from the second arm surface, the first protrusion, the second protrusion, the first recess and the second recess are configured such that when the first locking end engages with the first retention groove in the vertical direction and the second locking end engages with the second retention groove in the vertical direction, the first protrusion engages with the first recess in the vertical direction and the second protrusion engages with the second recess in the vertical direction to restrict further insertion of the insulative member in the vertical direction.

Optionally, the first protrusion, the second protrusion, the first recess, and the second recess are further configured such that when the insulative member is inserted between the first arm and the second arm, the first protrusion engages with the first recess in the lateral direction and the second protrusion engages with the second recess in the lateral direction to restrain the movement of the insulative member relative to the insulative housing in the lateral direction.

Optionally, the first resilient latch arm, the second resilient latch arm, the first retention groove and the second retention groove are further configured such that when the insulative member is inserted between the first arm and the second arm, the first locking end engages with the first retention groove in the lateral direction, and the second locking end engages with the second retention groove in the lateral direction to restrain the movement of the insulative member relative to the insulative housing in the lateral direction.

Optionally, when the insulative member is inserted between the first arm and the second arm, the first end surface engages with the first arm surface in the longitudinal direction and the second end surface engages with the second arm surface in the longitudinal direction to restrain the movement of the insulative member relative to the insulative housing in the longitudinal direction.

Optionally, for each of the plurality of conductive elements: the intermediate portion extends from a first surface of the body; the mating end is configured to be inserted into the body from the first surface in the lateral direction; and at least a portion of the intermediate portion between the mating end and the curved portion is held by the body.

Optionally, the body further comprises a second surface opposite to the first surface and a slot recessed into the body in the lateral direction from the second surface, the slot is configured for receiving the corresponding conductive portion of the electrical component, the mating ends of the plurality of conductive elements are exposed in the slot to establish an electrical connection with the corresponding conductive portion of the electrical component when the corresponding conductive portion is inserted in the slot.

Optionally, the tail ends of the plurality of conductive elements extend out of a bottom surface of the insulative member in the vertical direction, and the bottom surface faces a surface of the circuit board when the tail ends are mounted to the circuit board.

Optionally, the first arm and the second arm comprise a first bottom surface and a second bottom surface, respectively, and the first bottom surface and the second bottom surface face the surface of the circuit board when the tail ends are mounted to the circuit board, the bottom surface of the insulative member is flush with the first bottom surface and the second bottom surface.

Optionally, the tail ends of the plurality of conductive elements extend out of a bottom surface of the insulative member in the vertical direction, and the bottom surface faces a surface of the circuit board when the tail ends are mounted to the circuit board, the first resilient latching arm and the second resilient latching arm extend from a top surface of the insulative member opposite the bottom surface in the vertical direction adjacent to the first end surface and the second end surface, respectively.

Optionally, the insulative member comprises a plurality of channels extending through the insulative member in the vertical direction, each of the plurality of channels is configured to surround and retain at least the portion of the intermediate portion of a corresponding one of the plurality of conductive elements between the curved portion and the tail end.

Optionally, the plurality of conductive elements comprise a plurality of first conductive elements arranged in at least one row in the longitudinal direction; for the intermediate portion of each first conductive element, the curved portion is a first curved portion, the intermediate portion further comprises a first straight portion connected to the first curved portion and oriented in the vertical direction, a second straight portion connected to the tail end and oriented in the vertical direction, and a second curved portion connecting the first straight portion and the second straight portion, the first straight portions of the first conductive elements of each of the at least one row are coplanar in a plane substantially perpendicular to the lateral direction, and the second curved portions of two adjacent first conductive elements of each row are curved relative to the plane opposite to each other in the lateral direction, such that the second straight portions of the two adjacent first conductive elements are offset from each other in the longitudinal direction.

Optionally, the plurality of first conductive elements are arranged in two rows mutually opposed and spaced apart from each other in the longitudinal direction, the second curved portion of one of the two adjacent first conductive elements of one of the two rows is curved towards the other row, and the second curved portion of the other one of the two adjacent first conductive elements is curved away from the other row.

Optionally, the second straight portions of the two adjacent first conductive elements are spaced by the same distance from the plane.

Optionally, the first conductive elements of each of the at least one row have the same lengths from the mating ends to the tail ends thereof.

Optionally, the first conductive elements are configured as signal terminals for transmitting signal.

Optionally, the plurality of channels comprise a plurality of first channels each comprising a first channel portion configured for surrounding and holding the second straight portion of the intermediate portion of a corresponding one of the plurality of first conductive elements.

Optionally, the first channel further comprises a second channel portion communicated with the first channel portion in the vertical direction, the second channel portion is configured for receiving the second curved portion and the first straight portion of the corresponding first conductive element, the first channel and the corresponding first conductive element are dimensioned such that the corresponding first conductive element can be inserted into the second channel portion from a top surface of the insulative member, the tail end can pass through the second channel portion and the first channel portion and extend out of a bottom surface of the insulative member opposite to the top surface, the second straight portion can be received in the first channel portion, and the second curved portion and the first straight portion can be received in the second channel portion.

Optionally, a cross-section of the second channel portion perpendicular to the vertical direction has a T-shape, the T-shape comprises a narrower portion and a wider portion extending from the narrower portion in the lateral direction, the narrower portion is configured to allow the tail end, the second straight portion, and the second curved portion of the corresponding first conductive element to be inserted therein while blocking the first straight portion of the corresponding first conductive element from being inserted therein, and at least a portion of the narrower portion is aligned with the first channel portion in the vertical direction, the wider portion is configured for receiving the first straight portion of the corresponding first conductive element and for restraining the movement of the first straight portion in the lateral direction.

Optionally, the plurality of conductive elements comprise a plurality of second conductive elements, the intermediate portion of each of the plurality of second conductive elements further comprises a straight portion connecting the curved portion and the tail end and oriented in the vertical direction, the plurality of channels comprise a plurality of second channels each configured for surrounding and holding at least a portion of the straight portion of a corresponding one of the plurality of second conductive elements.

Optionally, the plurality of second conductive elements are arranged in a first row and a second row mutually opposed and spaced apart from each other in the longitudinal direction, a length of the straight portion of the second conductive element of the first row in the vertical direction is greater than a length of the straight portion of the second conductive element of the second row in the vertical direction, each of the plurality of second channels is configured to surround and hold the straight portion of a corresponding second conductive element of the first row and the second row over substantially the entire length of the straight portion in the vertical direction.

Optionally, the straight portion of each second conductive element comprises a first subportion connected to the curved portion and a second subportion connecting the first subportion and the tail end, a width of the first subportion in the longitudinal direction is greater than a width of the second subportion in the longitudinal direction, each second channel comprises a narrower portion and a wider portion extending from the narrower portion in the vertical direction, the narrower portion is configured to surround and hold the second subportion of the straight portion of the corresponding first conductive element while blocking the first subportion from being inserted therein, the wider portion is configured to surround and hold the first subportion of the straight portion of the corresponding first conductive element.

Optionally, the second conductive elements are configured as power terminals for transmitting power.

Optionally, the tail end is straight in the vertical direction.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, rear perspective view of an electrical connector, according to some embodiments;

FIG. 2 is a front, bottom perspective view of the electrical connector of FIG. 1;

FIG. 3 is an exploded perspective view of the electrical connector of FIG. 1;

FIG. 4 is a front view of the electrical connector of FIG. 1;

FIG. 5 is a top view of the electrical connector of FIG. 1;

FIG. 6 is a rear view of the electrical connector of FIG. 1;

FIG. 7 is a bottom view of the electrical connector of FIG. 1;

FIG. 8 is a perspective view of the electrical connector of FIG. 1, with an insulative member hidden;

FIG. 9 is a perspective view of the insulative housing of the electrical connector of FIG. 1;

FIG. 10 is another perspective view of the insulative housing of FIG. 9;

FIG. 11 is a cross-sectional view of the electrical connector of FIG. 1 taken along a line marked “I-I” in FIG. 5;

FIG. 12 is a cross-sectional view of the electrical connector of FIG. 1 taken along a line marked “II-II” in FIG. 5;

FIG. 13 is a cross-sectional view of the electrical connector of FIG. 1 taken along a line marked “III-III” in FIG. 5;

FIG. 14A is a top perspective view of the electrical connector of FIG. 1, with the insulative housing hidden;

FIG. 14B is a cross-sectional view of the electrical connector of FIG. 14A taken along a line marked “IV-IV” in FIG. 14A;

FIG. 15 is a top, front perspective view of the insulative member of the electrical connector of FIG. 1;

FIG. 16 is a top perspective view of the insulative member of FIG. 15;

FIG. 17A is a top view of the insulative member of FIG. 15;

FIG. 17B is an enlarged view of a portion of the insulative member of FIG. 15, highlighted by a dotted box labeled “A” in FIG. 17A;

FIG. 18 is a bottom view of the insulative member of FIG. 15;

FIG. 19 is a side view of first conductive elements of the electrical connector of FIG. 1;

FIGS. 20A to 20D are perspective views of four types of first conductive elements of the electrical connector of FIG. 1, respectively; and

FIGS. 21A and 21B are perspective views of two types of second conductive elements of the electrical connector of FIG. 1, respectively.

### DETAILED DESCRIPTION

The Inventors have recognized and appreciated designs that enable a reliable hybrid electrical connector to support both power and high speed signals within a compact space satisfying industry standards. Such connectors may be used, for example, in vehicles where vibration may cause connectors to unintentionally un-mate.

According to aspects of the present disclosure, a connector may include conductive elements each having a mating end, a tail end, and an intermediate portion joining the mating end and the tail end. The intermediate portion may comprise a curved portion, a first straight portion joining the curved portion and the mating end, and a second straight portion joining the curved portion and the tail end. Since the intermediate portion of the conductive element is curved, a portion of the intermediate portion of the conductive element adjacent to the tail end is prone to bend or even break when the connector is mounted to a circuit board and/or when a mating component (e.g., a card) is mated or unmated with the connector.

Techniques described herein can enhance connector reliability during operations. In some embodiments, an insulative member may be mounted to a housing and hold at least a portion of an intermediate portion of each of a plurality of conductive elements between a curved portion and a tail end. Such a configuration can effectively reduce the risk of accidentally bending portions of the intermediate portion of the conductive element when the electrical connector is mounted to a circuit board and/or when an electrical component is mated or unmated with the electrical connector, thereby improving the mechanical reliability of the electrical connector.

Techniques described herein can reduce connector footprints while maintaining signal transmission performance. In some embodiments, the signal terminals may be arranged in at least one row in a longitudinal direction. For each row, tail ends of two adjacent signal terminals may be offset from each other in the longitudinal direction. In this way, it is possible to arrange the signal terminals in a more compact manner while ensuring spacing among the signal terminals. Sufficient spacing can reduce crosstalk among the signal terminals. Such a configuration can reduce the footprint of the electrical connector on the circuit board while maintaining and/or improving signal transmission performance.

Techniques described herein can improve the efficiency of manufacturing electrical connectors. In some embodiments, the plurality of conductive elements may be configured to be inserted into a body of a housing in a lateral direction. The insulative member may be configured to be inserted between the first arm and the second arm of the housing in a vertical direction substantially perpendicular to the lateral direction such that the insulative member may be retained by the first arm and the second arm. Such a configuration can improve the manufacturing efficiency.

Some embodiments of the present application are described in detail below in conjunction with the accompanying drawings. It should be appreciated that these embodiments are not meant to form any limitations to the present application. Moreover, features in the embodiments of the present application may be used in any suitable combination.

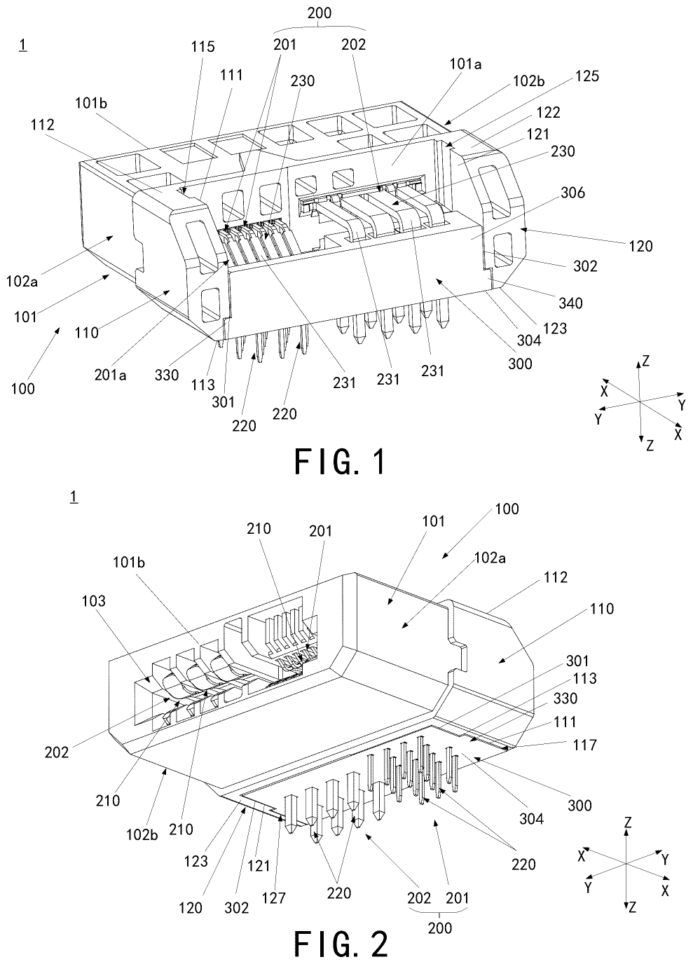

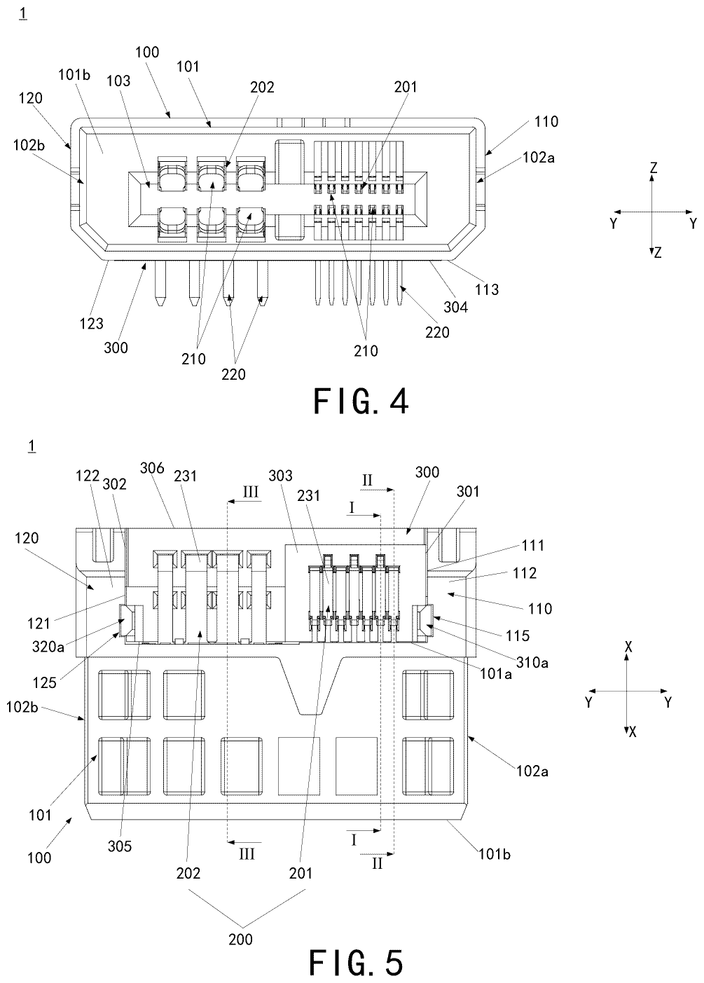

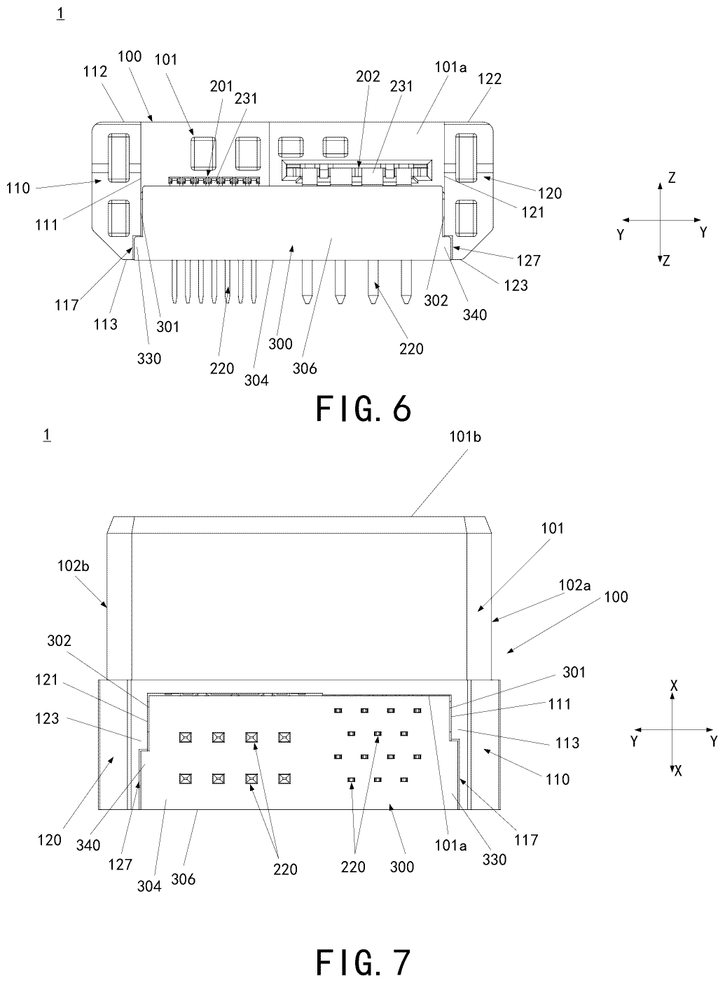

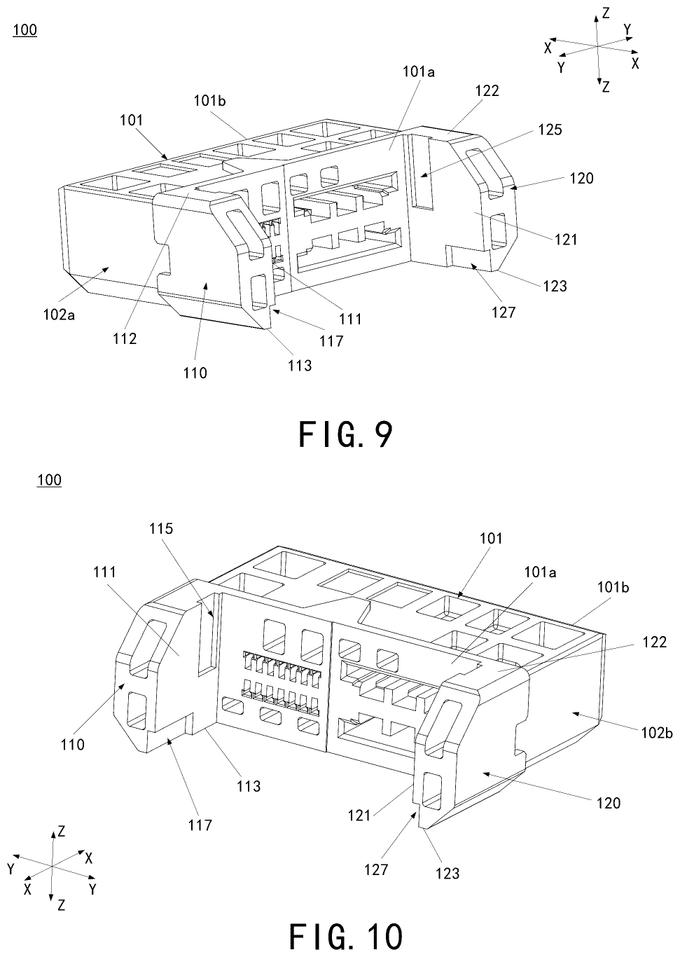

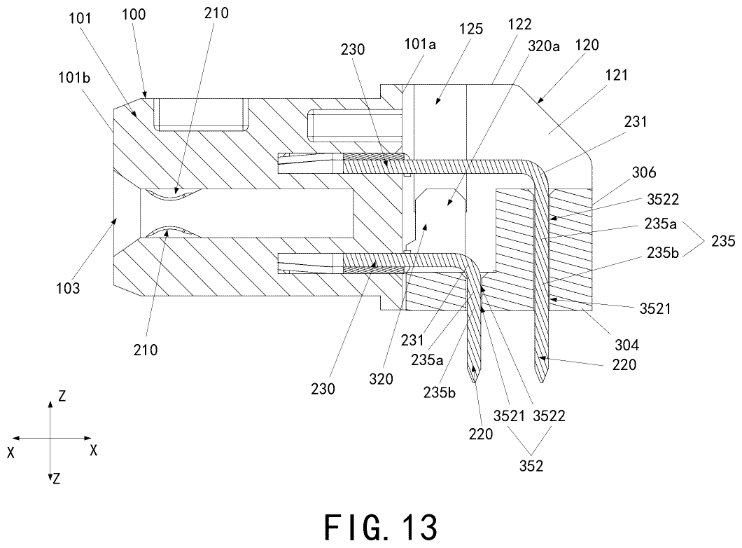

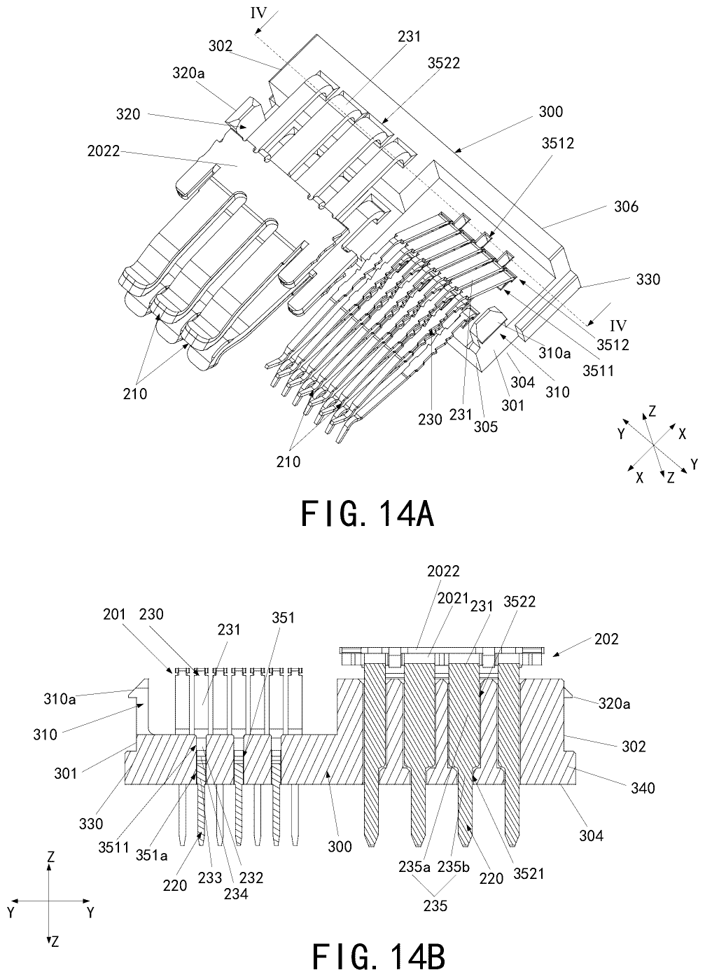

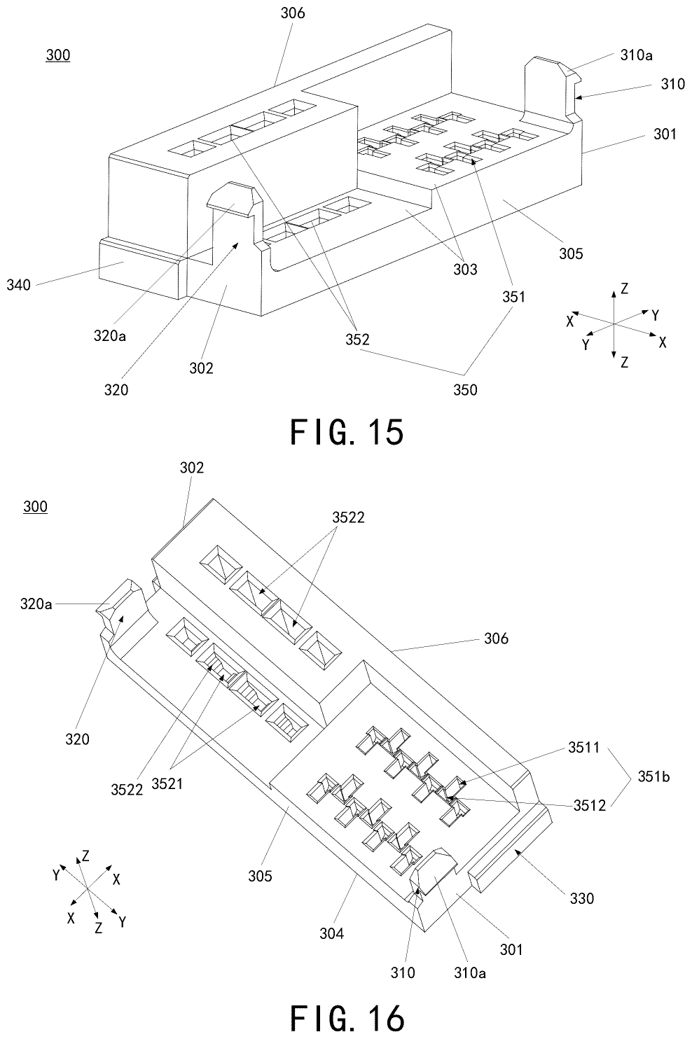

FIGS. 1 to 21B illustrate an electrical connector 1 according to some embodiments of the present application. The electrical connector 1 may be used to establish an electrical connection between a circuit board (not shown) and an electrical component (not shown). As illustrated, the electrical connector 1 is configured as a receptacle connector. For example, the circuit board may be a first circuit board (which may also be referred to as “a first printed circuit board” or “a first PCB”), and the electrical component may be a second circuit board (which may also be referred to as “a second printed circuit board” or “a second PCB”). For example, the first circuit board may be a motherboard, and the second circuit board may be a daughter card such as a solid state disk (SSD) card, a wireless communication card or an RF module. The electrical connector 1 may be mounted to that first circuit board, and a corresponding conductive portion of the second circuit board may be inserted into the electrical connector 1 such that an electrical connection can be established between the first circuit board and the second circuit board via the electrical connector 1. As another example, the electrical component may be a plug connector. The electrical connector 1 may be mounted to the circuit board, and a corresponding conductive portion of the plug connector may be inserted into the electrical connector 1 such that an electrical connection can be established between the circuit board and the plug connector via the electrical connector 1.

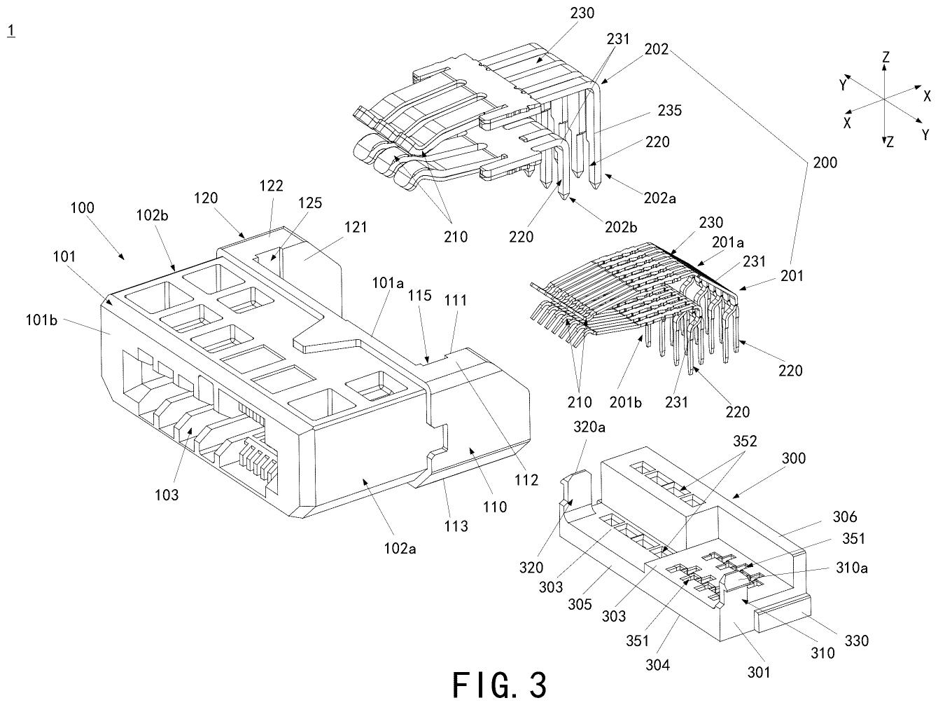

As illustrated in FIG. 3, the electrical connector 1 may include an insulative housing 100 and a plurality of conductive elements 200 disposed in the insulative housing 100.

For the sake of clarity and conciseness of the description, a lateral direction X-X, a longitudinal direction Y-Y, and a vertical direction Z-Z may be shown in the figures. The lateral direction X-X, the longitudinal direction Y-Y, and the vertical direction Z-Z may be perpendicular to each other. The lateral direction X-X may refer to a width direction of the electrical connector 1. The longitudinal direction Y-Y may refer to a length direction of the electrical connector 1. The vertical direction Z-Z may refer to a height direction of the electrical connector 1.

As shown in FIGS. 1 to 13, the insulative housing 100 may include a body 101. The body 101 may be formed from an insulative material. Examples of insulative materials that are suitable for forming the body 101 include, but are not limited to, plastic, nylon, liquid crystal polymer (LCP), polyphenylene sulfide (PPS), high temperature nylon or polyphenylene oxide (PPO) or polypropylene (PP).

As shown in FIGS. 1 to 8, 10 to 14B, and 19 to 21B, each of the plurality of conductive elements 200 may include a mating end 210, a tail end 220 opposite to the mating end 210, and an intermediate portion 230 extending between the mating end 210 and the tail end 220. Each of the plurality of conductive elements 200 may be formed from a conductive material. The conductive material suitable for forming the conductive elements 200 may include metal or metal alloy, such as copper or copper alloy. The mating end 210 may be configured for mating with a corresponding conductive portion of an electrical component such as the aforementioned second circuit board or the aforementioned plug connector, and the tail end 220 may be configured to be mounted to a circuit board such as the aforementioned first circuit board. The tail end 220 may be straight in the vertical direction Z-Z. For example, the first circuit board may include a conductive portion such as a conductive pad or a conductive through-hole, and the tail end 220 of the conductive element 200 may be configured to be connected to the conductive portion of the first circuit board by any suitable process known in the art (e.g., press fit or welding). For example, the second circuit board may include a conductive portion disposed at or near an edge thereof and may be inserted into the electrical connector 1 such that the conductive portion of the second circuit board contacts with the mating ends 210 of the conductive elements 200. In this way, the conductive elements 200 can establish an electrical connection between the conductive portion of the first circuit board and the conductive portion of the second circuit board, thereby enabling signal and/or power transmission. As another example, the plug connector may include a conductive portion disposed on a tongue portion, and the tongue portion may be inserted into the electrical connector 1 such that the conductive portion on the tongue portion contacts with the mating ends 210 of the conductive elements 200. In this way, the conductive elements 200 can establish an electrical connection between the conductive portion of the circuit board and the conductive portion of the plug connector, thereby enabling signal and/or power transmission.

As illustrated in FIGS. 1, 3, 8, 11 to 13, and 19 to 21B, the intermediate portion 230 of each of the plurality of conductive elements 200 may include a curved portion 231, which is curved such that the tail end 220 and the mating end 210 of the conductive element 200 are oriented to be substantially perpendicular to each other. When the plurality of conductive elements 200 are disposed in the insulative housing 100, the tail ends 220 are oriented in the vertical direction Z-Z, and the mating ends 210 are oriented in the lateral direction X-X, which is substantially perpendicular to the vertical direction Z-Z. With such a configuration, the electrical connector 1 can be mounted to the circuit board in the vertical direction Z-Z and mate with the corresponding conductive portion of the electrical component in the lateral direction X-X, thereby establishing an electrical connection between the electrical component and the circuit board.

Since the intermediate portion 230 of the conductive element 200 is curved, a portion of the intermediate portion 230 of the conductive element 200 adjacent to the tail end 220 is prone to be bent or even broken when the electrical connector 1 is mounted to the circuit board and/or when the electrical component is mated or unmated with the electrical connector 1 when the electrical connector 1 has already been mounted to the circuit board. To reduce the risk of such a situation, the electrical connector 1 may include an insulative member 300. The insulative member 300 is mounted to the insulative housing 100 and surrounds and holds at least a portion of the intermediate portion 230 of each of the plurality of conductive elements 200 between the curved portion 231 and the tail end 220.

With such a configuration, when the electrical connector 1 is mounted to the circuit board, and/or when the electrical component is mated or unmated with the electrical connector 1 when the electrical connector 1 has already been mounted to the circuit board, the insulative member 300 is capable of reducing the risk of the portion of the intermediate portion 230 adjacent to the tail end 220 (e.g., the portion of the intermediate portion 230 of the conductive element 200 between the curved portion 231 and the tail end 220) being deflected relative to the vertical direction Z-Z by surrounding and holding at least the portion of the intermediate portion 230 between the curved portion 231 and the tail end 220, thereby effectively reducing the risk of the situation that the portion of the intermediate portion 230 adjacent to the tail end 220 is bent or even broken. The electrical connector 1 has improved mechanical reliability compared to conventional electrical connectors. In addition, as will be described in detail below, since the insulative member 300 is mounted to the insulative housing 100 and surrounds and holds at least the portion of the intermediate portion 230 of the conductive element 200, the insulative member 300 is capable of assisting in holding the conductive element 200 in position relative to the insulative housing 100.

The insulative member 300 may be formed from an insulative material. Examples of insulative materials that are suitable for forming the insulative member 300 include, but are not limited to, plastic, nylon, liquid crystal polymer (LCP), polyphenylene sulfide (PPS), high temperature nylon or polyphenylene oxide (PPO) or polypropylene (PP).

The intermediate portion 230 of each of the plurality of conductive elements 200 may extend out of the body 101 of the insulative housing 100 in the lateral direction X-X and be curved to extend to the tail end 220 in the vertical direction Z-Z. For example, the curved portion 231 of the intermediate portion 230 and the tail end 220 of each of the plurality of conductive elements 200 are located outside of the body 101. As shown in FIGS. 1 to 13, the body 101 may include a first surface 101a and a second surface 101b opposite to each other in the lateral direction X-X and a first end 102a and a second end 102b opposite to each other in the longitudinal direction Y-Y. The intermediate portion 230 of each of the plurality of conductive elements 200 may extend out of the first surface 101a of the body 101 in the lateral direction X-X and may be curved to extend to the tail end 220 in the vertical direction Z-Z. The mating end 210 of each of the plurality of conductive elements 200 may be configured to be inserted into the body 101 from the first surface 101a in the lateral direction X-X. At least a portion of the intermediate portion 230 between the mating end 210 and the curved portion 231 may be held by the body 101 to help retain the conductive element 200 in position relative to the insulative housing 100. For example, at least a portion of the intermediate portion 230 between the mating end 210 and the curved portion 231 may include a barbed portion for engaging with a wall of a channel formed in the body 101. The body 101 may also include a slot 103 recessed into the body 101 from the second surface 101b in the lateral direction X-X. The slot 103 is configured for receiving the corresponding conductive portion of the electrical component. The mating ends 210 of the plurality of conductive elements 200 are exposed in the slot 103 to establish electrical connections with the corresponding conductive portion(s) of the electrical component when the corresponding conductive portion(s) of the electrical component is inserted into the slot 103. By providing that the insulative member 300 surrounds and holds at least a portion of the intermediate portion 230 of the conductive element 200 between the curved portion 231 and the tail end 220 and the body 101 holds at least a portion of the intermediate portion 230 between the mating end 210 and the curved portion 231, the conductive element 200 can be retained in position relative to the insulative housing 100.

As shown in FIGS. 1 to 13, the insulative housing 100 may also include a first arm 110 and a second arm 120. The first arm 110 and the second arm 120 may extend from the body 101 along the lateral direction X-X to opposite sides of the plurality of conductive elements 200 in the longitudinal direction Y-Y, respectively. In some examples, the first arm 110 and the second arm 120 may be positioned adjacent to the first end 102a and the second end 102b of the body 101, respectively. Alternatively or additionally, the first arm 110 and the second arm 120 may be integrally formed with the body 101, such as by injection molding. For example, the first arm 110 and the second arm 120 may extend from the first surface 101a of the body 101. It should be appreciated that the first arm 110 and the second arm 120 may also be formed separately from the body 101 and be attached to the body 101. The first arm 110 and the second arm 120 may be formed from the same material as the body 101, or may be formed from a different material from the body 101.

The insulative member 300 may be disposed between the first arm 110 and the second arm 120, and retained in position relative to the insulative housing 100 by the first arm 110 and the second arm 120. For example, when the insulative member 300 is disposed between the first arm 110 and the second arm 120 and is retained in position by the first arm 110 and the second arm 120, the first arm 110 and the second arm 120 restrain the movement of the insulative member 300 relative to the insulative housing 100 in the lateral direction X-X, the longitudinal direction Y-Y, and the vertical direction Z-Z. With such a configuration, it is possible to reliably secure the insulative member 300 to the insulative housing 100, thereby enabling the insulative member 300 to reliably hold the plurality of conductive elements 200.

In some embodiments, the insulative member 300 may be configured to be inserted between the first arm 110 and the second arm 120 in the vertical direction Z-Z so as to be retained by the first arm 110 and the second arm 120. As will be described in detail below, the efficiency of manufacturing and assembling the electrical connector 1 can be improved by such a configuration.

As shown in FIGS. 1 to 3, 5 to 7, 11 to 13, and 14A to 18, the insulative member 300 may include a first end surface 301 and a second end surface 302 opposite to each other in the longitudinal direction Y-Y, a top surface 303 and a bottom surface 304 opposing to each other in the vertical direction Z-Z, and a front surface 305 and a rear surface 305 opposite to each other in the lateral direction X-X. 306. The tail ends 220 of the plurality of conductive elements 200 may extend out of the bottom surface 304 of the insulative member 300 in the vertical direction Z-Z. When the electrical connector 1 is mounted to the circuit board, the bottom surface 304 of the insulative member 300 may face a surface of the circuit board.

As shown in FIGS. 1 to 3 and 5 to 10, the first arm 110 and the second arm 120 of the insulative housing 100 may include a first arm surface 111 and a second arm surface 121, respectively. The first arm surface 111 and the second arm surface 121 are opposite to each other in the longitudinal direction Y-Y. When the insulative member 300 is disposed between the first arm 110 and the second arm 120, the first end surface 301 of the insulative member 300 may face the first arm surface 111 of the first arm 110, the second end surface 302 of the insulative member 300 may face the second arm surface 121 of the second arm 120, and the front surface 305 of the insulative member 300 may face the first surface 101a of the insulative housing 100. The first arm 110 may include a top surface 112 and a bottom surface 113 opposite to each other in the vertical direction Z-Z, and the second arm 120 may include a top surface 122 and a bottom surface 123 opposite to each other in the vertical direction Z-Z. When the electrical connector 1 is mounted to the circuit board, the bottom surface 113 of the first arm 110 and the bottom surface 123 of the second arm 120 may face the aforementioned surface of the circuit board. In some examples, the bottom surface 304 of the insulative member 300 may be flush with the bottom surface 113 of the first arm 110 and the bottom surface 123 of the second arm 120. For example, the bottom surface 304 of the insulative member 300, the bottom surface 113 of the first arm 110, and the bottom surface 123 of the second arm 120 may together define a mounting interface for the electrical connector 1. With such a configuration, the insulative member 300 can be retained by the first arm 110 and the second arm 120 without increasing the height of the electrical connector 1 in the longitudinal direction Y-Y.

In some embodiments, as shown in FIGS. 3, 5, and 8 to 18, the insulative member 300 may include a first resilient latch arm 310 and a second resilient latch arm 320. The first resilient latch arm 310 may include a first locking end 310a extending beyond the first end surface 301 in the longitudinal direction Y-Y, and the second resilient latch arm 320 may include a second locking end 320a extending beyond the second end surface 302 in the longitudinal direction Y-Y. The first arm 110 of the insulative housing 100 may include a first retention groove 115 recessed into the first arm 110 from the first arm surface 111, and the second arm 120 may include a second retention groove 125 recessed into the second arm 120 from the second arm surface 121. The first resilient latch arm 310, the second resilient latch arm 320, the first retention groove 115, and the second retention groove 125 may be configured such that when the insulative member 300 is inserted between the first arm 110 and the second arm 120, the first locking end 310a engages with the first retention groove 115 in the vertical direction Z-Z, and the second locking end 320a engages with the second retention groove 125 in the vertical direction Z-Z to restrict a withdrawal of the insulative member 300 in the vertical direction Z-Z.

Alternatively, the first resilient latch arm 310, the second resilient latch arm 320, the first retention groove 115, and the second retention groove 125 may be configured such that, when the first locking end 310a engages with the first retention groove 115 in the vertical direction Z-Z and the second locking end 320a engages with the second retention groove 125 in the vertical direction Z-Z to secure the retention member 300 in the vertical direction Z-Z, a further insertion of the insulative member 300 in the vertical direction Z-Z is restricted. It should be appreciated that the movement of the insulative member 300 in the vertical direction Z-Z relative to the insulative housing 100 may be limited by any other suitable feature.

Alternatively or additionally, the first resilient latch arm 310, the second resilient latch arm 320, the first retention groove 115, and the second retention groove 125 may also be configured such that when the insulative member 300 is inserted between the first arm 110 and the second arm 120, the first locking end 310a engages with the first retention groove 115 in the lateral direction X-X and the second locking end 320a engages with the second retention groove 125 in the lateral direction X-X so as to restrain the movement of the insulative member 300 relative to the insulative housing 100 in the lateral direction X-X. It should be appreciated that, in some examples, the first resilient latch arm 310, the second resilient latch arm 320, the first retention groove 115, and the second retention groove 125 may be used as guiding features for guiding insertion of the insulative member 300 between the first arm 110 and the second arm 120. For example, when the insulative member 300 is initially inserted between the first arm 110 and the second arm 120, the first latching end 310a may engage with the first retention groove 115 in the lateral direction X-X and the second latching end 320a may engage with the second retention groove 125 in the lateral direction X-X to guide the insertion of the insulative member 300 and to limit the movement of the insulative member 300 relative to the insulative housing 100 in the lateral direction X-X. In some examples, the first locking end 310a engages with the first retention groove 115 in the lateral direction X-X and the second locking end 320a engages with the second retention groove 125 in the lateral direction X-X, only when the first locking end 310a engages with the first retention groove 115 in the vertical direction Z-Z and the second locking end 320a engages with the second retention groove 125 in the vertical direction Z-Z, so as to restrain the movement of the insulative member 300 relative to the insulative housing 100 in the lateral direction X-X.

The first resilient latch arm 310 and the second resilient latch arm 320 may extend from the top surface 303 of the insulative member 300 in the vertical direction Z-Z adjacent to the first end surface 301 and the second end surface 302, respectively. It should be appreciated that the present application is not limited thereto, and that the first resilient latch arm 310 and the second resilient latch arm 320 may be disposed in any other suitable manner to achieve at least one of the aforementioned functions.

Alternatively or additionally, as shown in FIGS. 1, 3, 6 to 10, and 14A to 18, the insulative member 300 may include a first protrusion 330 protruding from the first end surface 301 in the longitudinal direction Y-Y, and a second protrusion 340 protruding from the second end surface 302 in the longitudinal direction Y-Y. The first arm 110 of the insulative housing 100 may include a first recess 117 recessed into the first arm 110 from the first arm surface 111, and the second arm 120 may include a second recess 127 recessed into the second arm 120 from the second arm surface 121. As shown, the first recess 117 and the second recess 127 may each extend from the bottom surface 304 of the insulative member 300 in the vertical direction Z-Z. The first protrusion 330, the second protrusion 340, the first recess 117, and the second recess 127 may be configured such that when the insulative member 300 is inserted between the first arm 110 and the second arm 120 to bring the first locking end 310a into engagement with the first retention groove 115 in the vertical direction Z-Z and bring the second locking end 320a into engagement with the second retention groove 125 in the vertical direction Z-Z to secure the insulative member 300 in the vertical direction Z-Z, the first protrusion 330 engages with the first recess 117 in the vertical direction Z-Z and the second protrusion 340 engages with the second recess 127 in the vertical direction Z-Z to restrict the further insertion of the insulative member 300 in the vertical direction Z-Z. By providing the first resilient latch arm 310, the second resilient latch arm 320, the first retention groove 115, the second retention groove 125, the first protrusion 330, the second protrusion 340, the first recess 117, and the second recess 127, it is possible to restrain the movement of the insulative member 300 relative to the insulative housing in the vertical direction Z-Z, when the insulative member 300 is inserted between the first arm 110 and the second arm 120 in the vertical direction Z-Z.

Alternatively or additionally, the first protrusion 330, the second protrusion 340, the first recess 117, and the second recess 127 may be configured to restrain the movement of the insulative member 300 relative to the insulative housing 100 in the lateral direction X-X. In some examples, the first protrusion 330, the second protrusion 340, the first recess 117, and the second recess 127 may be used as guide features for guiding insertion of the insulative member 300 between the first arm 110 and the second arm 120. For example, the first recess 117 and the second recess 127 may each be in the form of a guiding groove extending from the bottom surface 304 of the insulative member 300 in the vertical direction Z-Z. When the insulative member 300 is initially inserted between the first arm 110 and the second arm 120, the first protrusion 330 may engage with the first recess 117 in the lateral direction X-X, and the second protrusion 340 may engage with the second recess 127 in the lateral direction X-X to guide the insertion of the insulative member 300 and to restrain the movement of the insulative member 300 relative to the insulative housing 100 in the lateral direction X-X. In some examples, the first protrusion 330 engages with the first recess 117 in the lateral direction X-X and the second protrusion 330 engages with the second recess 127 in the lateral direction X-X, only when the insulative member 300 is inserted between the first arm 110 and the second arm 120 to bring the first locking end 310a into engagement with the first retention groove 115 in the vertical direction Z-Z and bring the second locking end 320a into engagement with the second retention groove 125 in the vertical direction Z-Z, so as to limit the movement of the insulative member 300 relative to the insulative housing 100 in the lateral direction X-X. It should be appreciated that the movement of the insulative member 300 relative to the insulative housing 100 in the lateral direction X-X may be restrained by any other suitable feature(s).

In some embodiments, the first end surface 301 and the second end surface 302 of the insulative member 300 and the first arm surface 111 and the second arm surface 121 of the insulative housing 100 may be configured to restrain the movement of the insulative member 300 relative to the insulative housing 100 in the longitudinal direction Y-Y. As shown in FIGS. 1 and 5 to 7, when the insulative member 300 is inserted between the first arm 110 and the second arm 120, the first end surface 301 engages with the first arm surface 111 in the longitudinal direction Y-Y and the second end surface 302 engages with the second arm surface 121 in the longitudinal direction Y-Y to restrain the movement of the insulative member 300 relative to the insulative housing 100 in the longitudinal direction Y-Y. It should be appreciated that the movement of the insulative member 300 relative to the insulative housing 100 in the longitudinal direction Y-Y may be restrained by any other suitable feature(s).

In some embodiments, the first protrusion 330, the second protrusion 340, the first recess 117, and the second recess 127 may also be configured to restrain the movement of the insulative member 300 relative to the insulative housing 100 in the longitudinal direction Y-Y. For example, the first protrusion 330, the second protrusion 340, the first recess 117, and the second recess 127 may be configured such that when the insulative member 300 is inserted between the first arm 110 and the second arm 120, the first protrusion 330 engages with the first recess 117 in the longitudinal direction Y-Y, and the second protrusion 340 engages with the second recess 127 in the longitudinal direction Y-Y to restrain the movement of the insulative member 300 relative to the insulative housing 100 in the longitudinal direction Y-Y.

It should be appreciated that the features described above for restraining the movement of the insulative member 300 relative to the insulative housing 100 may be used in any suitable combination.

As shown in FIGS. 1 to 7 and 11 to 18, the insulative member 300 may include a plurality of channels 350 extending through the insulative member 300 in the vertical direction Z-Z. Each channel 350 may be configured to surround and hold at least the portion of the intermediate portion 230 of a corresponding one of the plurality of conductive elements 200 between the curved portion 231 and the tail end 220. In some embodiments, the channel 350 may be configured to surround and hold the entire length of the intermediate portion 230 of the corresponding conductive element 200 between the curved portion 231 and the tail end 220. In some embodiments, the channel 350 may be configured to surround and hold a portion of the length of the intermediate portion 230 of the corresponding conductive element 200 between the curved portion 231 and the tail end 220, such as a portion of the intermediate portion 230 adjacent to the tail end 220 or a portion of the intermediate portion 230 adjacent to the curved portion 231.

As shown in FIGS. 1 to 8, 11 to 14B, and 19 to 21B, the plurality of conductive elements 200 include a first conductive element 201 and a second conductive element 202. The first conductive element 201 may be configured as a signal terminal for transmitting signal, and the second conductive element 200 may be configured as a power terminal for transmitting power. Thus, the electrical connector 1 may be a hybrid electrical connector capable of transmitting both signal and power.

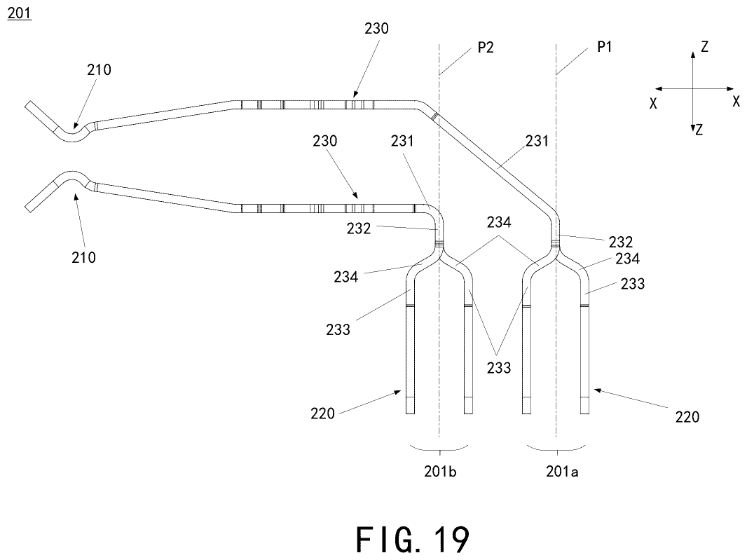

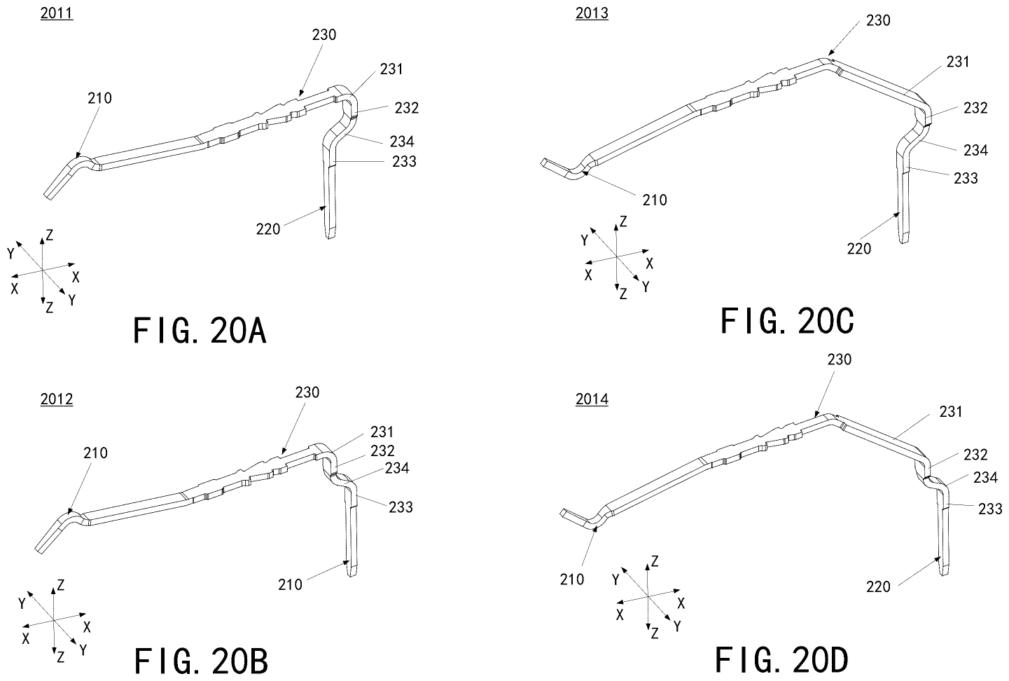

As shown in FIGS. 3 to 4, 8, 11 to 12, 14A, and 19, the plurality of conductive elements 200 may include a plurality of first conductive elements 201. Similar to those described above in connection with the conductive element 200, each of the first conductive elements 201 may include a mating end 210, a tail end 220 opposite to the mating end 210, and an intermediate portion 230 extending between the mating end 210 and the tail end 220. The intermediate portion 230 may include a curved portion 231, and the curved portion 231 is curved such that the tail end 220 and the mating end 210 of the first conductive element 201 are oriented to be substantially perpendicular to each other. When the first conductive element 201 is disposed in the insulative housing 100, the tail end 220 is oriented in the vertical direction Z-Z and the mating end 210 is oriented in the lateral direction X-X. As illustrated in FIGS. 19 to 20D, for the intermediate portion 230 of each first conductive element 201, the curved portion 231 is a first curved portion 231, and the intermediate portion 230 also includes a first straight portion 232 connected to the first curved portion 231 and oriented in the vertical direction Z-Z, a second straight portion 233 connected to the tail end 220 and oriented in the vertical direction Z-Z, and a second curved portion 234 connecting the first straight portion 232 and the second straight portion 233.

The plurality of first conductive elements 201 may be arranged in at least one row in the longitudinal direction Y-Y. The first straight portions 232 of the first conductive elements 201 of each of the at least one row may be coplanar in a plane substantially perpendicular to the lateral direction X-X, and the second curved portions 234 of two adjacent first conductive elements 201 of each row may be curved relative to the plane opposite to each other in the lateral direction X-X such that the second straight portions 233 of the two adjacent first conductive elements 201 are offset from to each other in the longitudinal direction Y-Y. This may result in that the tail ends 220 of the two adjacent first conductive elements 201 are offset from each other in the longitudinal direction Y-Y. In this way, it is possible to arrange the first conductive elements 201 in a more compact manner while ensuring a spacing between the two adjacent first conductive elements 201. Sufficient spacing can reduce crosstalk among the first conductive elements 201. Therefore, such a configuration can reduce the footprint of the electrical connector 1 on the circuit board while ensuring the signal transmission performance of the electrical connector 1, thereby providing a high-performance electrical connector 1 with a small footprint.

In some embodiments, as shown in FIGS. 3 to 4, 8, 11 to 12, 14A, and 19, the plurality of first conductive elements 201 are arranged in two rows (e.g., a first row 201a and a second row 201b) mutually opposed and spaced apart from each other in the longitudinal direction Y-Y. The first portions 232 of the first conductive elements 201 of the first row 201a are coplanar in a plane Pl (as schematically indicated by the dotted line in FIG. 19) substantially perpendicular to the lateral direction X-X, and the first portions 232 of the first conductive elements 201 of the second row 201b are coplanar in a plane P2 substantially perpendicular to the lateral direction X-X. The second curved portions 234 of two adjacent first conductive elements 201 of the first row 201a are curved opposite to each other in the lateral direction X-X relative to the plane P1 such that the second straight portions 233 of the two adjacent first conductive elements 201 are offset from to each other in the longitudinal direction Y-Y. The second curved portions 234 of the two adjacent first conductive elements 201 of the second row 201b are curved opposite to each other in the lateral direction X-X relative to the plane P2 such that the second straight portions 233 of the two adjacent first conductive elements 201 are offset from each other in the longitudinal direction Y-Y. The second curved portion 234 of one of the two adjacent first conductive elements 201 of one of the first row 201a and the second row 201b is curved towards the other of the two rows, and the second curved portion 234 of the other one of the two adjacent first conductive elements 201 is curved away from the other row.

In some embodiments, the second straight portions 233 of two adjacent first conductive elements 201 of each of the at least one row are spaced apart from the plane by the same distance. As illustrated in FIGS. 3 to 4, 8, 11 to 12, 14A, and 19, the second straight portions 233 of two adjacent first conductive elements 201 of the first row 201a are spaced apart from the plane P1 by the same first distance, and the second straight portions 233 of two adjacent first conductive elements 201 of the second row 201b are spaced apart from the plane P2 by the same second distance. The first distance may be the same as the second distance, or may be different from the second distance.

In some embodiments, the first conductive elements 201 of each of the at least one row have the same lengths from the mating ends 210 to the tail ends 220 thereof. As illustrated in FIGS. 3 to 4, 8, 11 to 12, 14A, and 19, the first conductive elements 201 of the first row 201a have the same lengths from the mating ends 210 to the tail ends 220 thereof, and the first conductive elements 201 of the second row 201b have the same lengths from the mating ends 210 to the tail ends 220 thereof. In this case, the first row 201a and the second row 201b may have first conductive elements 201 with four shapes, which are shown in FIGS. 20A to 20D and labeled with “2011, 2012, 2013, and 2014”, respectively, where the conductive elements 2011 and the conductive elements 2012 are two adjacent first conductive elements of the second row 201b, and the conductive element 2013 and the conductive element 2014 are two adjacent first conductive elements of the first row 201a.

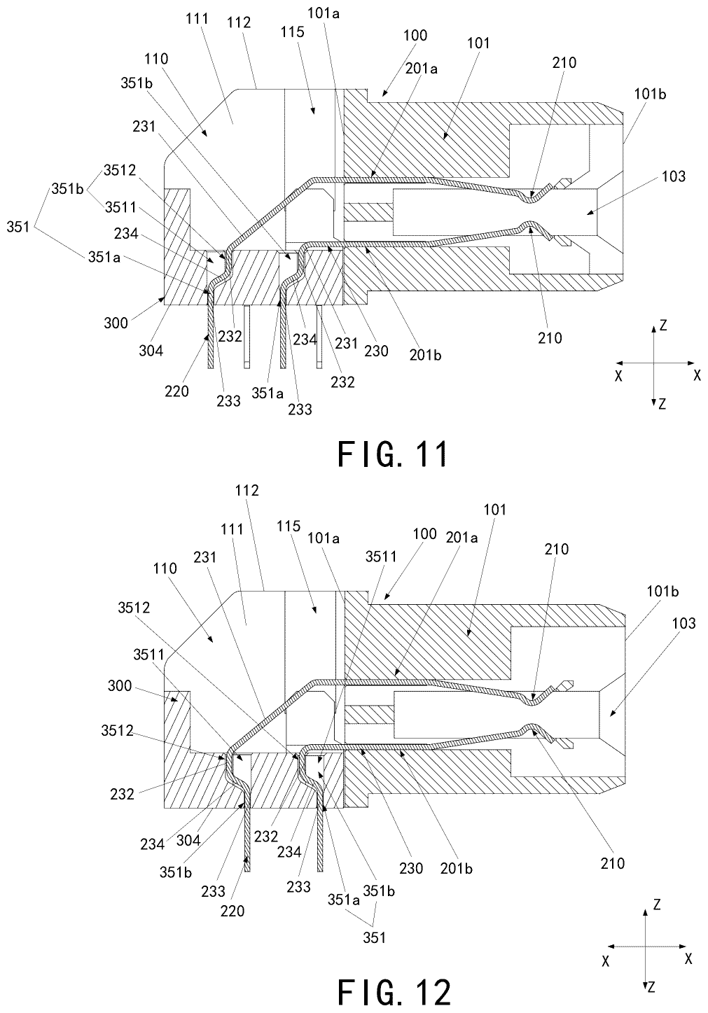

As shown in FIGS. 1 to 7 and 11 to 18, the plurality of channels 350 includes a plurality of first channels 351. As illustrated in FIGS. 11, 12, and 14B, each of the first channels 351 includes at least a first channel portion 351a. The first channel portion 351a is configured to surround and hold the second straight portion 233 of the intermediate portion 230 of a corresponding one of the plurality of first conductive elements 201. With such a configuration, when the electrical connector 1 is mounted to the circuit board, and/or when the electrical component is mated or unmated with the electrical connector 1 when the electrical connector 1 has already been mounted to the circuit board, the insulative member 300 is capable of reducing the risk of the portions of the intermediate portions 230 of the first conductive elements 201 adjacent to the tail ends 220 (e.g., the portions of the intermediate portions 230 of the first conductive elements 201 between the curved portions 231 and the tail ends 220) being deflected relative to the vertical direction Z-Z by surrounding and holding the second straight portions 233 of the first conductive elements 201, thereby effectively reducing the risk of the situation that the portions of the intermediate portions 230 adjacent to the tail ends 220 are bent or even broken. Furthermore, since the insulative member 300 is mounted to the insulative housing 100 and surrounds and holds the second straight portions 233 of the intermediate portions 230 of the first conductive elements 201, the insulative member 300 can help to retain the first conductive elements 201 in position relative to the insulative housing 100. In addition, when the first conductive elements 201 are configured as signal terminals for transmitting signal, the gaps among the insulative member 300 and the first conductive elements 201 can be effectively controlled by the insulative member 300, thereby ensuring the size of the gaps to meet the desired signal transmission requirements.

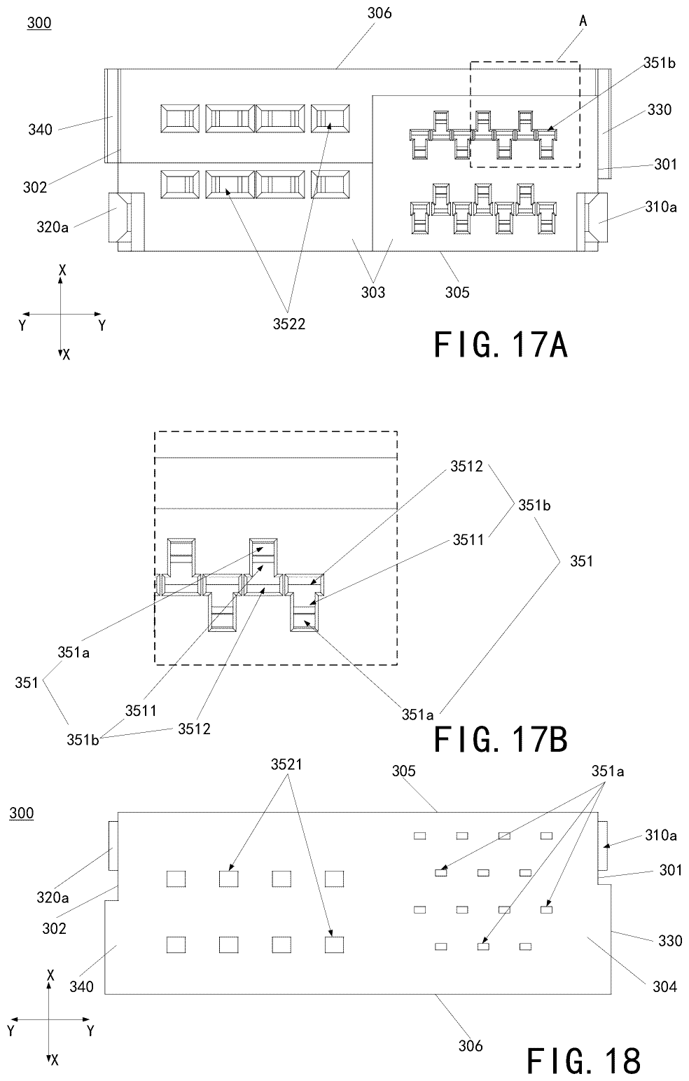

In some embodiments, as illustrated in FIGS. 11, 12, and 14B, the first channel 351 may also include a second channel portion 351b communicated with the first channel portion 351a in the vertical direction Z-Z. The second channel portion 351b may be configured for receiving the second curved portion 234 and the first straight portion 232 of the intermediate portion 230 of a corresponding first conductive element 201. As described above, the second straight portion 233 is offset from the first straight portion 232 in the vertical direction Z-Z due to the presence of the second curved portion 234. The dimension of the second channel portion 351b in the lateral direction X-X may be larger than the dimension of the first channel portion 351a in the lateral direction X-X, as shown in FIGS. 17A to 18. The first channel 351 and a corresponding first conductive element 201 may be dimensioned such that the corresponding first conductive element 201 can be inserted into the second channel portion 351b from the top surface 303 of the insulative member 300, the tail end 220 can pass through the second channel portion 351b and the first channel portion 351a and extend out of the bottom surface 304 of the insulative member 300, the second straight portion 233 can be received in the first channel portion 351a, and the second curved portion 234 and the first straight portion 232 can be received in the second channel portion 351b. When the second straight portion 233 is received in the first channel portion 351a, the first channel portion 351a may surround and hold the second straight portion 233.

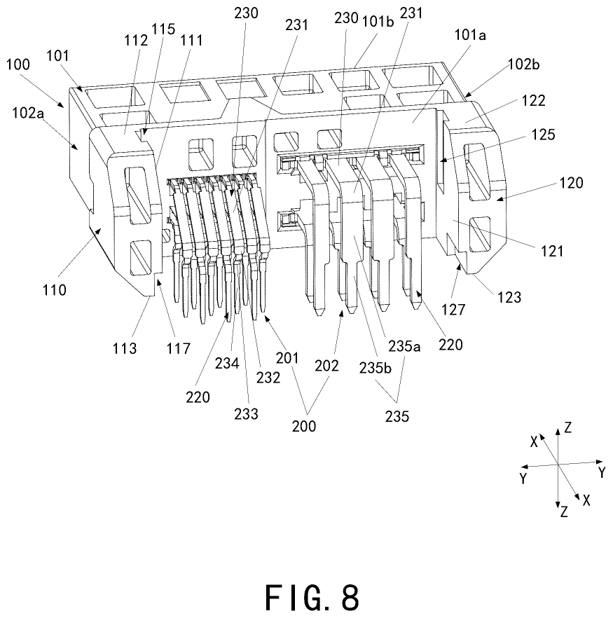

In the example illustrated in FIG. 17B, the cross-section of the second channel portion 351b of the first channel 351 perpendicular to the vertical direction Z-Z has a T-shape. The T-shape includes a narrower portion 3511 and a wider portion 3512 extending from the narrower portion 3511 in the lateral direction X-X. For example, a width of the wider portion 3512 in the longitudinal direction Y-Y is greater than a width of the narrower portion 3511 in the longitudinal direction Y-Y. As illustrated in FIG. 8, a width of the first straight portion 232 of a corresponding first conductive element 201 in the longitudinal direction Y-Y is greater than a width of the second curved portion 234 in the longitudinal direction Y-Y, and is greater than a width of the second straight portion 233 in the longitudinal direction Y-Y. The narrower portion 3511 may be configured to allow the tail end 220, the second straight portion 233, and the second curved portion 234 of the corresponding first conductive element 201 to be inserted therein, while blocking the first straight portion 232 of the corresponding first conductive element 201 from being inserted therein. For example, a width of the tail end 220, the second straight portion 233, and the second curved portion 234 of the corresponding first conductive element 201 in the longitudinal direction Y-Y is less than a width of the narrower portion 3511 in the longitudinal direction Y-Y, and a width of the first straight portion 232 in the longitudinal direction Y-Y is greater than a width of the narrower portion 3511 in the longitudinal direction Y-Y. At least a portion of the narrower portion 3511 is aligned with the first channel portion 351a in the vertical direction Z-Z (FIG. 17B). The wider portion 3512 may be configured for receiving the first straight portion 232 of a corresponding first conductive element 201 and for restraining the movement of the first straight portion 232 in the lateral direction X-X. A dimension of the wider portion 3512 in the lateral direction X-X may be slightly larger than a dimension of the first straight portion 232 in the lateral direction X-X to restrain the movement of the first straight portion 232 in the lateral direction X-X. In this way, the wider portion 3512 surrounds and holds the first straight portion 232. When the mating end 210 of the first conductive element 201 is subjected to a force in the lateral direction X-X (e.g., when the electrical component is mated or unmated with the electrical connector 1), the wider portion 3512 can restrain the movement of the first straight portion 232 in the lateral direction X-X to reduce the risk of the portion of the intermediate portion 230 between the curved portion 231 and the tail end 220 being deflected relative to the vertical direction Z-Z, thereby effectively reducing the risk of being bent or even broken.

As shown in FIGS. 3 to 4, 8, 13, 14A, and 21A to 21B, the plurality of conductive elements 200 may include a plurality of second conductive elements 202. It should be appreciated that the second conductive elements 202 illustrated in FIGS. 8, 13, 14B, 21A, and 21B is one exemplary form of the second conductive element, and the present application is not limited thereto. The second conductive elements 202 may be in any other suitable form.

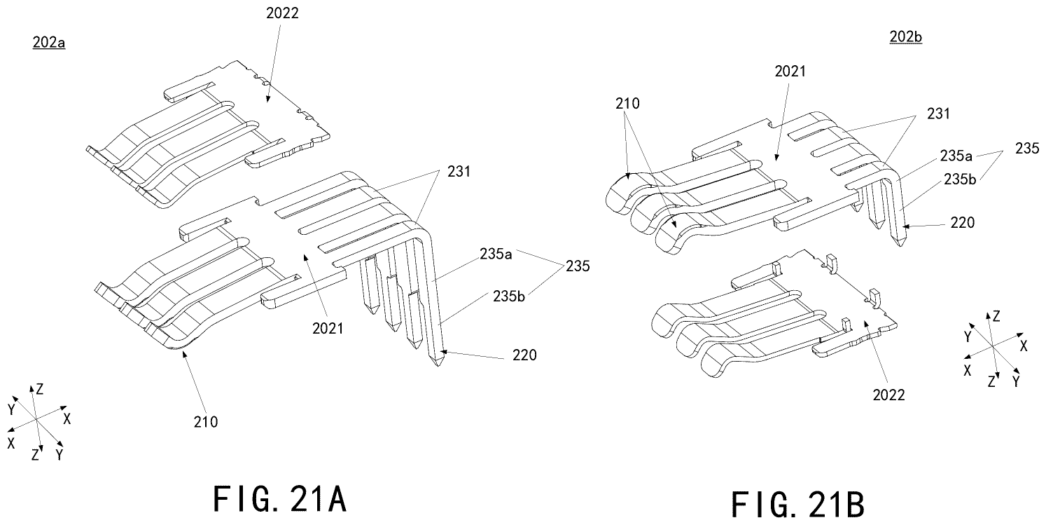

As shown in FIGS. 8, 13, 14B, 21A, and 21B, two second conductive elements 202 are shown (which are labeled with “201a” and “202b”, respectively). Each second conductive element 202 may include a plurality of first fingers extending from the base 2021 (FIGS. 21A and 21B) in the lateral direction X-X and oriented in the lateral direction X-X, and a plurality of second fingers extending opposite to the plurality of first fingers from the base 2021 and curved to be oriented in the vertical direction Z-Z. The base 2021 may be received and held by the body 101 of the insulative housing 100. End portions of the plurality of first fingers may be used as the mating end of the second conductive element 202 and are labeled with “210”. End portions of the plurality of second fingers are used as the tail end of the second conductive element 202 and are labeled with “220”. Thus, it should be appreciated that, similar to those described above in connection with the conductive element 200, each second conductive element 202 includes the mating end 210, the tail end 220 opposite to the mating end 210, and the intermediate portion 230 extending between the mating end 210 and the tail end 220. The intermediate portion 230 may include a curved portion 231, and the curved portion 231 is curved such that the tail end 220 and the mating end 220 of the first conductive element 201 are oriented to be substantially perpendicular to each other. When the second conductive element 202 is disposed in the insulative housing 100, the tail end 220 is oriented in the vertical direction Z-Z and the mating end 210 is oriented in the lateral direction X-X.

The intermediate portion 230 of each of the second conductive elements 202 also includes a straight portion 235 connecting the curved portion 231 and the tail end 220 and oriented in the vertical direction Z-Z. The plurality of channels 350 includes a plurality of second channels 352 each configured to surround and hold at least a portion of the straight portion 235 of a corresponding one of the plurality of second conductive elements 202. With such a configuration, when the electrical connector 1 is mounted to the circuit board, and/or when the electrical component is mated or unmated with the electrical connector 1 when the electrical connector 1 has already been mounted to the circuit board, the insulative member 300 is capable of reducing the risk of the portions of the intermediate portions 230 of the second conductive elements 202 adjacent to the tail ends 220 being deflected relative to the vertical direction Z-Z by surrounding and holding at least the portions of the straight portions 235 of the second conductive elements 202, thereby effectively reducing the risk of the situation that the portions of the intermediate portions 230 adjacent to the tail ends 220 are bent or even broken. In addition, since the insulative member 300 is mounted to the insulative housing 100 and surrounds and holds the straight portions 235 of the intermediate portions 230 of the second conductive elements 202, the insulative member 300 can help to retain the second conductive elements 202 in position relative to the insulative housing 100.

As shown in FIGS. 8, 13, 14B, 21A, and 21B, the two second conductive elements 202 are mutually opposed and spaced apart from each other. A length of the straight portion 235 of the second conductive element 202a in the vertical direction Z-Z is greater than a length of the straight portion 235 of the second conductive element 202b in the vertical direction Z-Z. Each second channel 352 is configured to surround and hold a corresponding straight portion 235 over substantially the entire length of the straight portion 235 in the vertical direction Z-Z.

It should be appreciated that there may be a plurality of second conductive elements 202 in any suitable form, and that these second conductive elements 202 may be arranged at least in a first row and a second row mutually opposed and spaced apart from each other in the longitudinal direction Y-Y. A length of the straight portion 235 of the second conductive element 202 of the first row in the vertical direction Z-Z may be greater than a length of the straight portion 235 of the second conductive element 202 of the second row in the vertical direction Z-Z. Each of the plurality of second channels 352 may be configured for surrounding and holding the straight portion 235 of a corresponding second conductive element 202 of the first and second rows along substantially the entire length of the straight portion 235 in the vertical direction Z-Z. As used herein, the term “substantially the entire length” may refer to, for example, a majority of the length, or almost the entire length, or the entire length, or an amount ranging from about 80% to about 100% of the length. In this way, when the mating end 210 of the second conductive element 202 is subjected to a force in the lateral direction X-X (e.g., when the electrical component is mated or unmated with the electrical connector 1), the second channel 352 can restrain the movement of the straight portion 235 in the lateral direction X-X to reduce the risk the portion of the intermediate portion 230 between the curved portion 231 and the tail end 220 being deflected in the vertical direction Z-Z, thereby effectively reducing the risk of being bent or even broken. It should also be appreciated that there may be only one row of second conductive elements 202, or any suitable number of rows of second conductive elements 202.

In some embodiments, the straight portion 235 of each second conductive element 202 may include a first subportion 235a connected to the curved portion 231 and a second subportion 235b connecting the first subportion 235a and the tail end 220. A width of the first subportion 235a in the longitudinal direction Y-Y may be greater than a width of the second subportion 235b in the longitudinal direction Y-Y. Each second channel 352 may include a narrower portion 3521 and a wider portion 3522 extending from the narrower portion 3521 in the vertical direction Z-Z. A width of the wider portion 3522 in the longitudinal direction Y-Y may be greater than a width of the narrower portion 3521 in the longitudinal direction Y-Y. The narrower portion 3521 may be configured for surrounding and holding the second subportion 235b of the straight portion 235 of a corresponding first conductive element 201 while blocking the first subportion 235a from being inserted therein. A width of the narrower portion 3521 in the longitudinal direction Y-Y may be less than a width of the first subportion 235a in the longitudinal direction Y-Y. The wider portion 3522 may be configured to surround and hold the first subportion 235a of the straight portion 235 of a corresponding first conductive element 201. For example, the second channel 352 and a corresponding second conductive element 202 may be dimensioned such that the corresponding second conductive element 202 can be inserted into the wider portion 3522 from the top surface 303 of the insulative member 300, the tail end 220 can extend through the wider portion 3522 and the narrower portion 3521 and out of the bottom surface 304 of the insulative member 300 opposite to the top surface 303, the second subportion 235b can be received in the narrower portion 3521, and the first subportion can be received in the wider portion 3522. With such a configuration, the narrower portion 3521 can provide support to the straight portion 235 of the second conductive element 202, restraining the movement of the straight portion 235 in the second channel 352 in the vertical direction Z-Z, thereby further reducing the risk of the second conductive element 202 from being bent or even broken.

In some embodiments, each second conductive element 202 may include a reinforcement member 2022 mounted on the base 2021 and extending from the base 2021 to the mating end 210. The reinforcement member 2022 may enhance the strength of the second conductive element 202 at the mating end 210. The reinforcing member 2022 may be formed from a material such as stainless steel. It should be appreciated that the present application is not limited thereto and may be devoid of the reinforcement member 2022.

The present application also provides a method for assembling the electrical connector 1 as described above. The method includes first assembling the plurality of conductive elements 200 (including the first conductive elements 201 and the second conductive elements 202) into the insulative housing 100. For example, the mating end 210 of each of the plurality of conductive elements 200 is inserted into the body 101 in the lateral direction X-X from the first surface 101a of the body 101 of the insulative housing 100. At least a portion of the intermediate portion 230 between the mating end 210 and the curved portion 231 may be held by the body 101. The holding member 300 is then inserted between the first arm 110 and the second arm 120 of the insulative housing 100 in the vertical direction Z-Z to be held by the first arm 110 and the second arm 120. The insulative member 300 surrounds and holds at least a portion of the intermediate portion 230 of each of the plurality of conductive elements 200 between the curved portion 231 and the tail end 220. The configuration of the electrical connector 1 according to the present application can improve the efficiency of manufacture and assembly.

It should be appreciated that the insulative member 300 may be configured to be inserted between the first arm 110 and the second arm 120 of the insulative housing 100 in any other direction(s). For example, the insulative member 300 may be configured to be inserted between the first arm 110 and the second arm 120 in the lateral direction X-X. In this case, the plurality of conductive elements 200 may first be mounted on the insulative member 300, and the combination of the plurality of conductive elements 200 and the insulative member 300 may subsequently be inserted between the first arm 110 and the second arm 120 in the lateral direction X-X. It is also possible to first mold the insulative member 300 on the plurality of conductive elements 200, and then insert the combination of the plurality of conductive elements 200 and the insulative member 300 between the first arm 110 and the second arm 120 in the lateral direction X-X. It should also be appreciated that except for being mounted to the insulative housing 100 by the first arm 110 and the second arm 120, the insulative member 300 may be mounted to the insulative housing 100 by any other suitable mechanism.

It should also be appreciated that the electrical connector 1 may have only the first conductive element 201 or the second conductive element 202, or may have any other suitable type of conductive elements.

It should also be appreciated that the electrical connector 1 may include any suitable mechanism for securing the electrical connector 1 to the circuit board. For example, the electrical connector 1 may include a locking tab for securing the body 101 of the insulative housing 100 to the circuit board.

It should also be appreciated that the electrical connector 1 may be configured as any other suitable type of connector. The electrical connector 1 may be configured as a plug connector, and the mating end 210 of the conductive element 200 may be exposed at a plug portion. As another example, the electrical connector 1 may be configured as a cable connector, and the mating end 210 of the conductive element 200 may be connected with a cable.

Such alterations, modifications, and improvements are intended to be within the spirit and scope of the invention. Accordingly, the foregoing description and drawings are by way of example only.

All definitions, as defined and used, should be understood to control over dictionary definitions, definitions in documents incorporated by reference, and/or ordinary meanings of the defined terms.

Numerical values and ranges may be described in the description and claims as approximate or exact values or ranges. For example, in some cases, the terms “about,” “approximately,” and “substantially” may be used in reference to a value. Such references are intended to encompass the referenced value as well as plus and minus reasonable variations of the value.

In the claims, as well as in the description above, all transitional phrases such as “comprising,” “including,” “carrying,” “having,” “containing,” “involving,” “holding,” “composed of,” and the like are to be understood to be open-ended, e.g., to mean including but not limited thereto. Only the transitional phrases “consisting of” and “consisting essentially of” shall be closed or semi-closed transitional phrases, respectively.

The claims should not be read as being limited to the described order or elements unless explicitly stated. It should be understood that various changes in forms and details may be made by one of ordinary skill in the art without departing from the spirit and scope of the appended claims. All embodiments that come within the spirit and scope of the following claims and equivalents thereof are claimed.

It should also be appreciated that the terms “first” and “second” are only used to distinguish an element or component from another element or component, and that these elements and/or components should not be limited by the terms.

The present application has been described in detail in conjunction with specific embodiments. Obviously, the above description and the embodiments shown in the appended drawings should be understood to be exemplary and do not constitute a limitation to the present application. For a person skilled in the art, various variations or modifications can be made without departing from the spirit of the present application, and these variations or modifications fall within the scope of the present application.

1. An insulative member for restraining movement of conductive elements of an electrical connector, the insulative member comprising:
a first portion comprising a top surface, a bottom surface, and a plurality of first channels extending from the top surface to the bottom surface, each of the plurality of first channels configured for holding at least a portion of a respective first conductive element of the electrical connector, the plurality of first channels disposed in first and second rows aligned in a mating direction of the electrical connector, each of the first and second rows extending in a longitudinal direction perpendicular to the mating direction; and
a second portion connected to and aligned with the first portion in the longitudinal direction, the second portion comprising a first top surface, a second top surface offset from the first top surface in a vertical direction perpendicular to the longitudinal direction, a bottom surface, and a plurality of second channels, each of the plurality of second channels configured for holding at least a portion of a respective second conductive element of the electrical connector, the plurality of second channels comprising a first row of second channels extending from the first top surface to the bottom surface, and a second row of second channels extending from the second top surface to the bottom surface.

2. The insulative member of claim 1, comprising:
a first resilient latch arm extending from a first end surface of the first portion and comprising a first locking end extending beyond the first end surface in the longitudinal direction.

3. The insulative member of claim 2, wherein:
the first portion comprises a first protrusion protruding from the first end surface in the longitudinal direction and offset from the first resilient latch arm in the mating direction.

4. The insulative member of claim 2, comprising:
a second resilient latch arm extending from a second end surface of the second portion and comprising a second locking end extending beyond the second end surface in the longitudinal direction.

5. The insulative member of claim 1, wherein:
the top surface of the first portion is disposed between the first and second top surfaces of the second portion in the vertical direction.

6. The insulative member of claim 5, wherein:
the bottom surfaces of the first and second portions are flush with each other.

7. The insulative member of claim 1, wherein:
each of the plurality of first channels comprises a first channel portion extending to the bottom surface and a second channel portion extending to the top surface, the second channel portion connected to and aligned with the first channel portion in the vertical direction; and
the second channel portion of each of the plurality of first channels has a T-shaped cross-section in a plane perpendicular to the vertical direction.

8. The insulative member of claim 7, wherein:
each of the plurality of second channels comprises a narrower portion extending to the bottom surface, and a wider portion extending to either the first top surface or the second top surface, the wider portion connected to and aligned with the narrower portion in the vertical direction.

9. An electrical connector comprising:
a housing comprising a body having a front, mating face and a rear face, and first and second arms extending from the rear face of the body and away from the mating face; and
the insulative member of claim 1 disposed between the first and second arms of the housing.

10. An electrical connector comprising:
a housing comprising a body having a front, mating face and a rear face, and first and second arms extending from the rear face of the body and away from the mating face;
a plurality of conductive elements, each of the plurality of conductive elements comprising a mating end, a tail end, and an intermediate portion joining the mating end and the tail end, the intermediate portion comprising a curved portion, a first straight portion joining the curved portion and the mating end, and a second straight portion joining the curved portion and the tail end; and
an insulative member configured to restrain movements of the plurality of conductive elements, the insulative member disposed between the first and second arms of the housing and holding at least a portion of the second straight portion of the intermediate portion of each of the plurality of conductive elements.

11. The electrical connector of claim 10, wherein:
the plurality of conductive elements comprise a plurality of first conductive elements configured for transmitting signals, and a plurality of second conductive elements configured for transmitting power; and
the body of the housing comprises
a first portion holding the mating end and at least a portion of the first straight portion of the intermediate portion of each of the plurality of first conductive elements,
a second portion holding the mating end and at least a portion of the first straight portion of the intermediate portion of each of the plurality of first conductive elements, and
a slot extending from the first portion to the second portion in a longitudinal direction and accessible from the mating face; and
the mating ends of the plurality of conductive elements accessible from the slot.

12. The electrical connector of claim 11, wherein:
the insulative member comprises a plurality of channels; and
each of the plurality of channels comprises:
a first channel portion configured to receive a portion of the curved portion of the intermediate portion of each of the plurality of conductive elements, and
a second channel portion narrower than the first channel portion in at least one direction and configured to hold the at least a portion of the second straight portion of the intermediate portion of each of the plurality of conductive elements.

13. The electrical connector of claim 10, wherein:
the insulative member comprises a front face abutting against the rear face of the housing.

14. The electrical connector of claim 13, wherein:
the first and second arms of the housing comprise first and second arm surfaces facing each other; and
the insulative member comprises a first end surface, and a first resilient latch arm extending from the first end surface and configured to engage with the first arm surface of the first arm of the housing.

15. The electrical connector of claim 14, wherein:
the first arm comprises a first arm surface and a first groove recessed into the first arm from the first arm surface; and
the first resilient latch arm comprises a first locking end configured to engage with the first groove.

16. The electrical connector of claim 15, wherein:
the insulative member comprises a second end surface opposite to the first end surface, and a second resilient latch arm extending from the second end surface and configured to engage with the second arm surface of the second arm of the housing.

17. The electrical connector of claim 16, wherein:
the second arm comprises a second arm surface and a second groove recessed into the second arm from the second arm surface; and
the second resilient latch arm comprises a second locking end configured to engage with the second groove.

18. The electrical connector of claim 15, wherein:
the first arm further comprises a first recess in the first arm from the first arm surface;
the second arm further comprises a second recess in the second arm from the second arm surface; and
the insulative member further comprises a first protrusion protruding from the first end surface and configured to engage with the first recess, and a second protrusion protruding from the second end surface and configured to engage with the second recess.

19. An electronic system comprising:
a circuit board comprising a surface; and
an electrical connector mounted on the circuit board, the electrical connector comprising:
a housing comprising a body having a bottom face configured to disposed on the surface of the circuit board, a front, mating face, a rear face, and first and second arms extending from the rear face of the body and away from the mating face;
a plurality of conductive elements, each of the plurality of conductive elements comprising a mating end, a tail end, and an intermediate portion joining the mating end and the tail end, the intermediate portion comprising a curved portion; and
an insulative member configured to restrain movements of the plurality of conductive elements, the insulative member disposed between the first and second arms of the housing and comprising a bottom face flush with the bottom face of the housing.

20. The electronic system of claim 19, wherein:
the first arm and the second arm comprise a first bottom surface and a second bottom surface, respectively; and
the first bottom surface and the second bottom surface are flush with the bottom face of the insulative member.
